(19) United States
(12) Patent Application Publication
(10) Pub. No.: US 2006/0165579 A1
(43) Pub. Date: Jul. 27, 2006

(54) Void-free superconducting magnesium diboride

(76) Inventors: Harry Jones, Alexandria, VA (US); Michael Osofsky, Clarksville, MD (US); Chia Feng, Arlington, VA (US); Khershed Cooper, Fairfax, VA (US); Chandra Pande, McLean, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 11/042,120

(22) Filed: Jan. 26, 2005

(51) Int. Cl. C01B 25/08; C01B 35/02; B32B 15/04; B32B 9/04

(52) U.S. Cl. 423/289; 428/457; 428/704

(57) ABSTRACT

This invention pertains to a void-free superconducting magnesium diboride (MgB₂) product, especially wire, and to a method for its fabrication. The product is a well-connected and void-free superconducting magnesium diboride. The fabrication method includes the steps of: 1) charging a metal billet or tube with magnesium and boron, or magnesium diboride; 2) sealing the billet; 3) heating the filled and sealed billet to an elevated temperature above room temperature at which the billet metal can be hot-worked and at which reaction between magnesium and boron to form magnesium diboride proceeds or magnesium diboride can be deformed; and 4) hot-rolling the billet until the desired magnesium diboride dimensions and the reaction are achieved. There is an optional step of hot-treating the billet after hot-rolling to change superconducting properties of magnesium diboride by modifying microstructure thereof.

### FIELD OF THE INVENTION

This invention is directed to superconducting magnesium diboride product and its fabrication by hot rolling deformation processing at an elevated temperature a billet containing magnesium and boron, or a fully reacted magnesium diboride obtained from other sources. The resulting product, typically wire, contains a well-connected, void-free superconducting magnesium diboride core which is held under compressive stress by the billet that becomes the sheath.

### DESCRIPTION OF THE BACKGROUND

The intermetallic compound magnesium diboride (MgB₂) was first investigated in 1953 and only recently, has it been identified as a Type II superconductor with a transition temperature of 39 K (−393° F.). Type II superconductors have industrial value and can be partially penetrated by a magnetic field without destroying superconductivity, whereas Type I superconductors do not have any known industrial value and lose superconductivity upon penetration by a magnetic field.

This discovery has predictably resulted in many attempts to fabricate superconducting products, especially wire, from this compound. Due to the chemical reactivity of magnesium with most container or sheath materials at high temperatures, and the brittleness of this intermetallic compound, fabrication of wire and other products is a challenging problem. Since the compound has been commercially available from chemical supply firms for many years, initial attempts at fabrication of magnesium diboride wire and other products were to use the commercially available material inside of a metallic tube.

Some of the first attempts to fabricate magnesium diboride superconducting wire employed the classic powder-in-tube process developed for the manufacture of flux cored welding wires, and is a widely available technology. The powdered superconducting compound is introduced into a U-shaped metallic strip which is folded over into a tubular geometry. This tube is subsequently cold drawn at about the room temperature into a wire which also compacts the powder inside. The amount of reduction by cold drawing is limited by the work hardening characteristics of the sheath material, which is typically steel, and the compaction behavior of the powder. The wire is then heated under a protective or inert atmosphere after drawing to sinter the superconducting powder. After this sintering anneal, no further deformation processing is possible at ambient temperature due to the hard and brittle nature of magnesium diboride.

When the magnesium diboride compound is introduced into the tube as a fully reacted powder, it is termed the “ex situ” powder-in-tube process. Wires fabricated using this method suffer from poor sintering characteristics of the commercial magnesium diboride powder which is invariably contaminated with about a micron-thick layer of magnesium oxide. This oxide coats the particles and leads to both incomplete sintering and poor internal connectivity within the magnesium diboride superconductor.

The other commonly employed method is the “in situ” powder-in-tube process where magnesium and boron elemental powders are mixed. This mixture is introduced into a U-shaped strip of metal, as described before for the ex-situ powder-in-tube process. After cold drawing into a wire, it is heated to react the powders to form the magnesium diboride core. Because the folded over tube is not perfectly sealed, even after cold drawing, this heat treatment is normally conducted under an inert atmosphere to prevent oxidation of magnesium.

The primary limitation of the in situ approach is the void formation resulting from the increased density of the fully reacted magnesium diboride compared to that of the compacted starting materials. Even if perfect packing of the starting elemental powders could be achieved, a void volume fraction on the order of 30% will still result.

In practice, since perfect packing of the powders cannot be attained with the powder-in-tube process, void volume fractions of up to 50% are observed. This void content is undesirable since it limits both the cross sectional area and the internal connectivity of the magnesium diboride superconductor. Also, if steel is used as a sheath material, the level of compressive stress induced in the core by the steel sheath is reduced due to increased compliance of the core resulting from the void content.

### OBJECTS AND BRIEF SUMMARY OF THE INVENTION

An object of this invention is a void-free magnesium diboride superconducting product, particularly wire.

Another object of this invention is a thinner superconducting magnesium diboride wire, or another elongated product, than is possible with prior art technique.

Another object of this invention is a superconducting magnesium diboride wire that can carry more current than a prior art superconducting magnesium diboride wire.

Another object of this invention is a method for making a well-connected, void-free superconducting magnesium diboride product that has enhanced critical current density compared to prior art.

Another object of this invention is fabrication of a superconducting magnesium diboride product at an elevated temperature above room temperature.

Another object of this invention is fabrication of a multifilament or multiconductor superconducting magnesium diboride wire by hot rolling an assembly of multiple single filament wires or multiple filament wires inside a tube at an elevated temperature to produce a void-free superconducting wire with reduced AC loss compared to prior art.

Another object of this invention is fabrication of a superconducting magnesium diboride in a metal billet by hot rolling the billet metal at an elevated temperature at which the billet metal can be hot-worked and at which the reaction between magnesium and boron proceeds to form superconducting magnesium diboride encased in the billet material.

Another object of this invention is fabrication of superconducting magnesium diboride wire encased in a metal billet by hot rolling the billet at an elevated temperature whereby diameter of the magnesium diboride core can be manipulated.

These and other objects of this invention can be achieved by fabricating superconducting magnesium diboride elongated product in a metal billet by hot rolling the billet at an elevated temperature at which the billet can be hot-worked and at which the reaction between magnesium and boron to form magnesium diboride proceeds (in situ), or the fully reacted magnesium diboride can be deformed into a small diameter (ex situ).

### BRIEF DESCRIPTION OF THE DRAWINGS

FIG. 1 shows components used to assemble a billet or preform for hot rolling into wire powdered boron, granular magnesium, steel plug and drilled blank.

FIG. 2 shows a polished cross-section of the steel sheathed superconducting magnesium diboride wire with a 2 mm diameter core.

FIG. 3 shows an iron boride (FeB and FeB₂) boundary between magnesium diboride (MgB₂) and the steel (Fe) sheath.

FIG. 4 shows a transverse fracture surface through the magnesium diboride core.

FIG. 5 shows a longitudinal slice of the hot rolled magnesium diboride core material mounted on a glass slide for resistivity and transition temperature measurements.

FIG. 6 is a graph of resistivity of the hot-rolled magnesium diboride core material as a function of temperature.

FIG. 7 is a graph of magnesium vapor pressure variation with temperature and also shows melting pont at 649° C., vapor pressure of 12.9 kPa at 900° C. and boiling point of 1090° C.

FIG. 8 is a graph of magnetic field intensity variation with current.

### DETAILED DESCRIPTION OF THE INVENTION

This invention is directed to a superconducting, or lossless conduction of current, magnesium diboride (MgB₂) wire, or another product, and to a method for fabricating metal-sheathed superconducting product in which the magnesium diboride is void-free. In another embodiment, the product is void-fee but can have porosity to the extent of being greater than about 98% void-free. The product also does not show the sausaging effect, i.e., pinching off the superconducting core material by the sheath material at large reductions of up to 90% and greater. The method includes the steps of:

1) charging a metal billet or tube with magnesium diboride or with boron and magnesium;

2) sealing the billet;

3) heating the charged and sealed billet to an elevated temperature above room temperature at which the billet metal can be hot-worked and at which reaction between magnesium and boron to form magnesium diboride proceeds or magnesium diboride deforms;

4) hot-rolling the billet until the desired dimensions and the reaction are achieved; and

5) cooling the tube.

There is an optional step of hot-treating the billet after hot-rolling to change superconducting properties of magnesium diboride by modifying microstructure thereof; and

The unobvious and unexpected feature of this invention is the ability to manipulate or reduce outside diameter of the product which includes a sheath and a continuous strand of a uniform diameter section of a superconducting, void-free and well-connected magnesium diboride under compressive stress at room temperature. The stress is imparted to magnesium diboride by the sheath due to the reason that coefficient of expansion of the sheath is greater than that of magnesium diboride and therefore, upon cooling from high temperature, the compressive stresses develop. The void-free nature of magnesium diboride core promotes superior current capacity and superconductivity property.

The metal billet, which can be of any metal or alloy that does not react with magnesium, is typically of a ferrous metal, such as steel. To produce a billet container 12, shown in FIG. 1, with required characteristics, a 19 mm-diameter steel bar stock was cut into 63.5 mm lengths. A 6.3 mm diameter hole 14 was then drilled in the piece of bar stock to a depth of 50.8 mm. A 25.4 mm length of 6.3 mm steel bar stock was cut for use as a plug 16. Approximately 0.5 grams of powdered amorphous dark brown boron 18 of less than 5-micron average particle size was weighed out and placed inside a small vial 20. This material was about 95% pure, with the primary impurity being oxygen. Powdered boron is a flammable material and can produce eye and lung irritation. Ingestion thereof in sufficient amount will cause boron poisoning. As a result, this material must be handled under a hood.

The stoichiometric amount of silvery magnesium was calculated on the basis of the amount of boron weighed out in the first vial. An additional 10% by weight of the stoichiometric requirement of magnesium was then added to the calculated amount to compensate for the oxide layer of the granular magnesium, the oxygen impurity in the boron and the residual air that remained inside the billet container after sealing. The required amount of the magnesium granules 22 was weighed out and placed inside a separate vial 24. The components used to produce a charged preform for an in situ hot rolling experiment are shown in FIG. 1.

The powdered boron was introduced into the drilled cavity first with a series of compactions. The granular magnesium was then rammed into the cavity. It is not necessary to have a uniform mixture of boron and magnesium particles for a complete reaction due to mechanical working of the core. To seal the billet container, the plug was inserted into the cavity and loaded with a hydraulic press. This press, which can apply forces of up to 3000 kilograms, employed a 10 mm diameter hardened steel ball as the ram platen. The ram platen was placed on the end of the plug and force was applied to compact the charge. When the yield strength of the steel plug was exceeded, the plug expanded and produce a mechanical and hermetic seal. Additional force was applied to the point that the projecting end of the plug continued to expand and peen over. This compaction method provided an airtight seal prior to arc welding the end of the billet container. The inserted plug was then arc welded to produce a seal that would remain intact during hot deformation.

The resulting billet container was heated to 900° C. and held there for 2 hours prior to hot rolling. About 12-14 reheats were employed to reduce the billet preform from about 19 mm to about 6 μm outside diameter, 610 mm (24 inches) long and 5.8 mm×5.1 mm rectangular wire. The working temperature is affected by the equipment used but should be high enough to facilitate hot rolling of the billet and to facilitate the reaction between boron and magnesium. Typically, the hot rolling temperature to form void-free superconducting magnesium diboride of this invention is above about 800° C. for ferrous metals, especially in the range of 800° C. to 1400° C. Higher temperatures are not used because of hot shortness, or inability to deform.

The reaction mechanism between polycrystalline boron and magnesium vapor at 900° C. produces magnesium diboride (MgB₂) in the form of small, 1-2 μm diameter hexagonal plate-like crystals. These crystals are loosely bound together on the boron substrate and are very friable. The volume expansion that occurs when magnesium diboride forms inside the grain boundaries of the polycrystalline boron tends to break it up into particles roughly corresponding to the grain size of 20-80 microns. These particles then become coated with the small magnesium diboride crystallites with increasing exposure time to magnesium vapor. At this point, the reaction rate slows as the layer of the magnesium diboride crystallites forms a diffusion barrier which slows further magnesium transport to the MgB₂/B interface. Some of the other boron-rich phases, such as MgB₄ and MgB₇, are also probably present in this interface region.

Hot rolling is a deformation processing technique used in steel mills and other metals industries to produce structural shapes, bars of various cross sections and plate. As such, it is a very common and widely available processing technique. The material to be rolled is heated to reduce the forces required to deform it into a useful shape. A slow speed hot mill with “diamond” grooved rolls was used here. The maximum groove size was a 14.2 mm square. From this size down, there were eleven grooves with the smallest being a 6.3 mm round.

In deformation processing by hot rolling, the billet is first placed inside a furnace to heat it up to the desired temperature, which typically depends on the type of equipment used. Upon attainment of the hot working temperature, the billet is quickly removed from the furnace and inserted into one of the grooves in the rolling mill. The rotation of the rolls draws the billet into the groove and reduces the cross section area and elongates it. Depending on the speed of the mill, which can be as high as 20-30 mph in modern mills, the material may actually increase in temperature due to the mechanical work done on it by the mill. In the case of the slow speed mill used herein, it was necessary to reheat the billet back to the hot working temperature after each pass through the mill. After a series of reheats and passes through grooves of decreasing dimensions, a billet was reduced to a nominal 6.3 mm diameter.

For “in situ” hot rolling conducted here, in order to demonstrate that this technique was a feasible processing route, several issues arose, particularly those related to safety. Since liquid magnesium at 900° C. would literally explode into flame if exposed to air, the design and construction of the billet container became critical. The billet container wall thickness had to be sufficient to avoid the possibility of a breach during hot rolling. The sealing method also had to be robust and survive the 90%, or greater, reductions in area produced by hot rolling. Typically, area reductions of up to 95% are experienced with hot rolling the billet Another consideration was to minimize the amount of material handled so that in the event of a breach, the consequences would be controlled. Typically, with any deformation process and with a ferrous metal, such as steel, the starting sheath thickness is from about 6 mm to about 3 mm or less. After hot-rolling, the sheath thickness is reduced to 2 to 1.5 mm and the magnesium diboride core is typically 8 mm to 0.5 mm in outside dimension, more typically from 1 mm to 10 mm, depending on the initial size of the billet. These core diameters can be further reduced or manipulated by repeated hot-rollings.

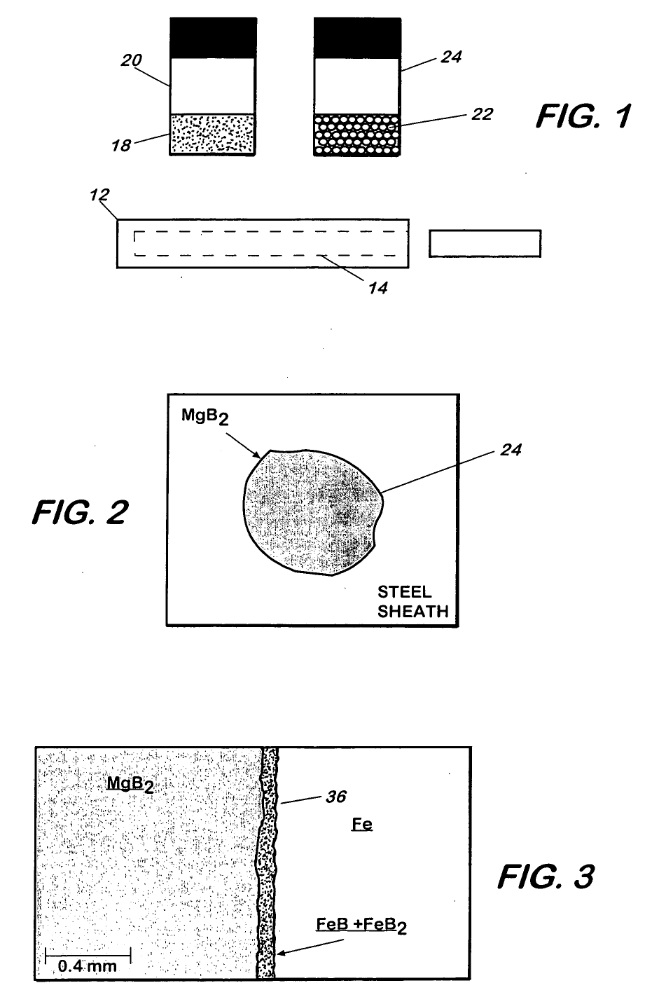

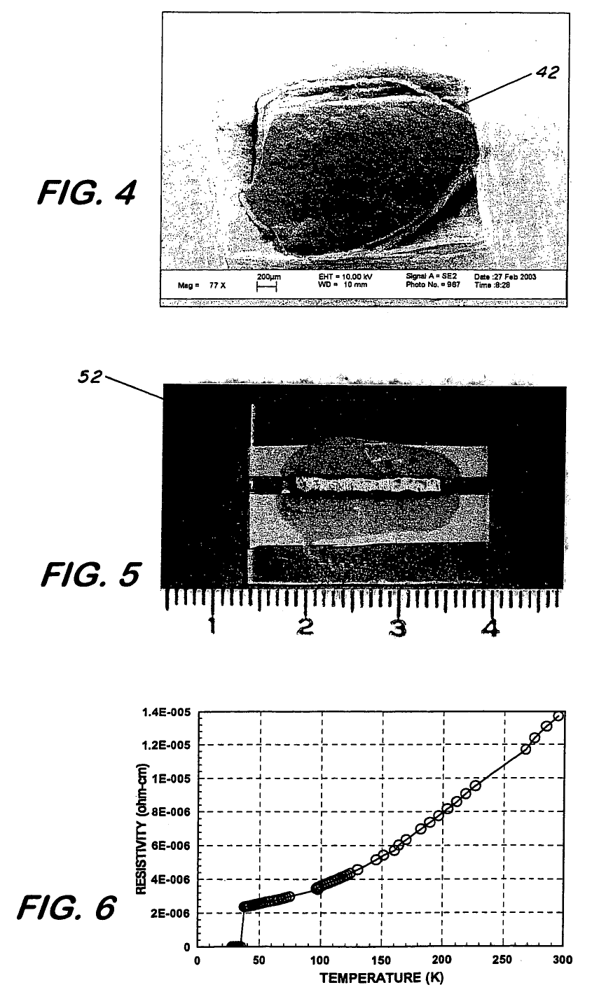

Cross sections were cut from the core rod 24 to examine the magnesium diboride core 22. FIG. 2 shows a polished cross section of the core, which is about 2 mm in diameter. The core material exhibited some dark areas associated with the magnesium oxide (MgO) inherited from the magnesium granules where pieces of the core chipped out during the polishing process. The boundary between the magnesium diboride core and the steel sheath is shown in FIG. 3 where an interface layer 36 of iron boride (FeB and FeB₂) is found. Further metallographic examination at higher magnifications indicated the presence of a few isolated boron particles that had not completely reacted with the magnesium. Cutting a circumferential notch in the sheath and then bending the wire generated a transverse fracture surface in the core material. This fracture surface 42, shown in FIG. 4, exhibits no voids. There are some features associated with the magnesium oxide (MgO) inclusions that were originally on the surfaces of the granular starting material.

The in situ hot rolling process exploits two effects inside the billet cavity that contains the starting materials. First, during the preheating prior to hot rolling, there is some vapor phase transport and liquid phase infiltration of the magnesium into the boron powder. As the billet is rolled, liquid phase infiltration is forced into the remaining unreacted boron since the volume of the original cavity is being reduced. Secondly, fracturing and deformation of the core material may also be occurring which can open up new paths for diffusion and transport of magnesium to the boron particles. The net result is a fully reacted core material within the time it takes to complete the hot rolling process.

Magnesium diboride, with a transition temperature of 39K, is a binary intermetallic line compound that must be exposed to an equilibrium vapor pressure of magnesium at every step of a processing technique. It does not melt but decomposes when the magnesium vapor pressure is not sufficient. Exposure of the powdered magnesium diboride form to air, results in the formation of magnesium oxide (MgO) and magnesium hydrides on the surface of the particles. The surface contamination of the particles of the powdered form can make sintering into a homogeneous, well connected solid very difficult.

An important figure of merit for a superconductive wire is the critical current density, J_{c}. This is the maximum current density that the wire can sustain without loss and is a function of temperature and applied magnetic field. In a bulk, type II superconductor, there are two critical magnetic fields, H_{c1} and H_{c2}. Below H_{c1}, magnetic flux is expelled from the bulk of the superconductor. Between H_{c1} and H_{c2}, is the “mixed state” where magnetic field penetrates the superconductor as quantized flux tubes surronded by circulating vortex currents, each with a flux density of about 2×10⁻⁷ gauss-cm². The cores of the flux tubes are in the normal state, hence the term “mixed state.” Above H_{c2}, the upper critical field, the material is a normal conductor. In the mixed state, current flow produces a Lorentz force on the flux. If the force is great enough to cause the fluxoids to move, then the current does work, thus inducing loss or resistance, in the superconductor.

Typically, J_{c} is defined as the current density that produces enough loss to result in a 1 μV drop across the sample. Therefore, for a useful superconductor, the flux must be pinned in place by defects in the material, such as small second phase particles, grain boundaries or dislocations. These defects must have a dense distribution in order to be effective at high magnetic fields where the flux density is high. As a result, the microstructure of the superconductor must be manipulated in a manner that will provide effective pinning centers for large critical currents, Thus, the ideal processing method should produce dense material with good connectivity and a large defect density for strong flux pinning. Amount of a suitable dopant is typically on the order of 1-10%, based on the weight of the magnesium diboride, and its particle size is on the order of 10-100 nm.

The resulting wire was allowed to cool in air after hot rolling and inspected for cracks or breaches. To insure that the core material was fully sintered, the wire was optionally again heated to 920° C. and held for 30 minutes and then allowed to furnace cool after power cutoff. The result was a 610 mm (24 inches) long in situ hot rolled wire.

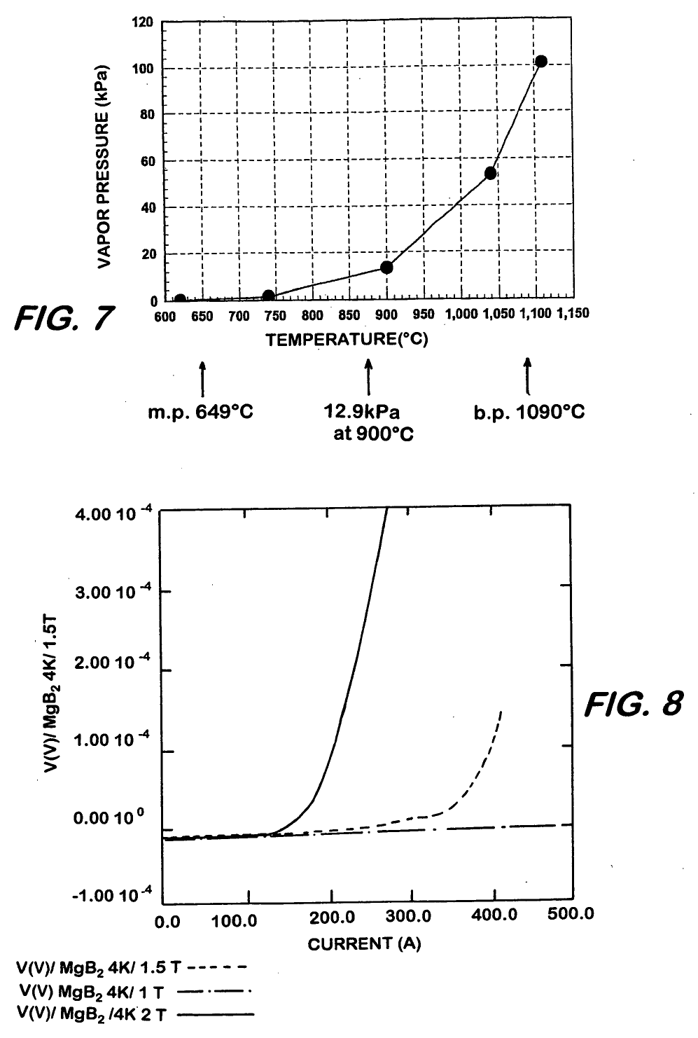

To extract a sample of the magnesium diboride (MgB₂) core material for tests without fracture, tape was applied to the two attached pieces of the sheath. These pieces of tape functioned as a release agent. This assembly was then glued to a glass slide 52, as shown in FIG. 5. The sheath material was wedged off the tape with a razor blade leaving the core attached to the glass slide. Resistivity and transition temperature measurements were made on this longitudinal slice. The results are shown in FIG. 6 where a low resistivity of 2.4 μΩcm is just above T_{c}. In FIG. 6, the sharp change in resistivity at about T_{c} is an indication of a good superconductor. In connection with FIG. 6, 2E-006 is 2×10⁻⁶. Particle size of the doping materials should be nanosize but greater than the coherence length, or typically not less than about 10 nm and amount thereof is 1-10% by weight. Although much higher magnetic fields can be used of up to about 12 Tesla, at which current would be negligible, a magnetic field of 2 Tesla is considered moderate and sufficient for MRI and other applications, such as transformers. In normal use, the magnesium diboride product is typically used to generate a suitable magnetic field. FIG. 7 shows melting point of magnesium diboride of 649° C., its vapor pressure of 12.9 kPa at 900° C. and boiling point of 1090° C.

Inductive critical current (J_{c}) measurements were made on a 1.8 mm long transverse slice of the core removed from the sheath using a Quantum Design SQUID MPMS system. Critical current estimates derived from magnetization curves suggest J_{c} on the order of 10⁶ amps/cm² at 5 K in zero magnetic field. These results are encouraging and indicate that a superior quality magnesium diboride (MgB₂) core geometry with good superconducting properties can be produced using the combination of an in situ synthesis reaction coupled with simultaneous hot deformation.

To further explore the mechanical behavior of magnesium diboride at elevated temperatures, a 28 mm length of the rod produced in the first in situ hot rolling trial was inserted into one of the drilled 19 mm diameter blanks. An addition of 0.05 g of magnesium was made prior to sealing to provide a vapor source to prevent decomposition of the magnesium diboride. This preform was sealed, as described before, and hot rolled into a 559 mm long wire. This was, in essence, an ex situ hot rolling experiment where the magnesium diboride was fully sintered and not in a powdered form. No sintering anneal after hot rolling was done on this wire.

A cross section cut from this wire indicated that the core material, originally 2 mm in diameter, had been reduced to about 0.5 mm. Examination of a polished longitudinal section indicated a blocky microstructure. Closer examination of the core material using a transverse fracture surface indicated that it contained fractures and shear bands. The fracture surface was not flat and clean, as was observed with the original 2 mm core. The longitudinal polished section indicated that the core material accommodated the diameter reduction by a combination of fracture, shearing and plastic deformation processes, as suggested by the blocky nature of the microstructure. Based on the experiences with the first in situ experiment, it is assumed that this fractured microstructure can be modified by a sintering anneal after hot rolling. This experiment served to demonstrate that a fully reacted and consolidated magnesium diboride core can be manipulated or reduced by further deformation processing and that the steel sheath is harder than the magnesium diboride at 900° C.

The demonstration that the magnesium diboride core diameter can be manipulated by hot rolling, suggested that a multiconductor or multifilament wire can be fabricated by the same technique. As used herein, a “multifilament product” is a single wire containing multiple and evenly or unevenly spaced magnesium diboride superconductor strands To demonstrate the feasibility of this concept, four pieces of hot rolled wire with 2 mm core diameters, processed as described before, were cut into 60 mm lengths. These were inserted into a steel tube and sealed by arc welding. This assembly was then hot rolled down to a 6.3 mm square wire. The resulting cross section indicates that the cores were deformed to a smaller diameter of 0.8 mm. This multiconductor hot rolled wire was given a 30 minute sintering anneal after hot rolling. The core material, on a metallographic basis, appears to be well consolidated, fully sintered and continuous. FIG. 8, which pertains to a multiconductor wire, shows that the four filament superconducting magnesium diboride wire at 2 Tesla can carry about 150 amps of current. This current quantity can be increased by doping to get pinning centers in the superconducting magnesium diboride with materials such as carbon or silicon carbide.

The multiconductor filaments can be fabricated by initially fabricating the product, as described above, and then packing the product into a tube, and then hot-roll it until the desired dimensions are attained. This can be further processed by any desired hot-treatment. This process can be repeated to obtain the desired number of conductors/filaments for reduction of AC losses and to promote flux jumping stabilization. Additionally, the product with multiple conductors can be twisted while hot to produce a helical winding, which can further reduce AC losses. Outside diameter of the multiconductor product can be that of a single conductor product, with the individual conductors being very small in diameter.

The processing method, described above, eliminates voids that occur with the prior art “in situ” powder-in-tube process and also minimizes the magnesium oxide contamination that is encountered with the “ex situ” powder-in-tube process. As the result of the mechanical match produced at 900° C. between the magnesium diboride superconducting core and the steel sheath, the compressive forces exerted on the core at cryogenic temperatures of about 20 K, due to the difference in thermal expansion coefficients, are far larger that are achievable with the powder-in-tube process. Because the magnesium diboride core material undergoes mechanical working during the deformation processing, the nanoscale defect density or dislocations needed for effective flux pinning is greatly increased. This, along with the compressive stresses induced in the core, can improve the critical current capacity of the superconductor. Synthesis of magnesium diboride from the elements, processing into a wire or another shape or product, and the introduction of defects into the crystal structure for flux pinning, are combined into one operation. This processing can be accomplished with equipment that already exists at steel and wire mills, and results in a very low cost superconducting product.

Hot extrusion and hot drawing are other deformation processing that can also be used, as well as processing above and below 900° C.

While presently preferred embodiments have been shown of the novel superconducting product and process, and of the several modifications discussed, persons skilled in this art will readily appreciate that various additional changes and modifications can be made without departing from the spirit of the invention, as defined and differentiated by the following claims.

What is claimed is:

1. A superconducting magnesium diboride (MgB₂) product that is void free to the extent of greater than about 98% having transition temperature of about 39K.

2. The product of claim 1 wherein the product is elongated.

3. The product of claim 1 comprising a metal sheath with magnesium diboride disposed within the sheath and being held under compressive stress imparted by said sheath.

4. The product of claim 3 wherein said metal is steel.

5. The product of claim 4 containing 1 weight % to 10 weight % of dopant particles distributed throughout said product, based on the weight of the magnesium diboride.

6. The product of claim 4 in the form of a wire wherein said sheath is steel.

7. The product of claim 5 wherein said dopant is selected from the group consisting of carbon, silicon carbide, and mixtures thereof, and particle size of said dopant is 10 nm to 100 nm.

8. A method for fabricating a superconducting magnesium diboride (MgB₂) product that is void-free to the extent of greater than 98% and having transition temperature of about 39K, comprising the steps of
(a) charging a tube with magnesium diboride or components thereof;
(b) sealing the tube;
(c) heating the charged and sealed tube to an elevated temperature above room temperature;
(d) hot-deformation processing of the tube; and
(e) cooling the tube.

9. The method of claim 8 wherein the boron is in powdered form and magnesium are introduced into the.

10. The method of claim 9 wherein said heating step is to a temperature of above about 800° C.

11. The method of claim 9 wherein said heating step is to a temperature in the range of about 800° C. to 1400° C.

12. The method of claim 11 wherein said step of hot rolling is conducted to reduce cross-sectional area of the tube of up to 95%.

13. The method of claim 11 wherein the product consists of a sheath and a magnesium diboride core that is void-free.

14. The method of claim 13 wherein said step of sealing is conducted to create an air-tight seal of the tube and the method includes the step of cooling the tube after its hot rolling.

15. The method of claim 14 wherein said step of charging is conducted in air.

16. The method of claim 15 wherein the tube is robust enough so that it avoids breaching or fracturing during said hot rolling step.

17. The method of claim 16 wherein the tube is made of steel and the product is well-connected.

18. The method of claim 17 including the step of doping the product by adding a suitable dopant.

19. The method of claim 18 wherein the dopant is selected from group consisting of carbon, silicon carbide, and mixtures thereof; particle size of the dopant is 10 nm to 100 nm; and amount of the dopant is 1 weight % to 10 weight %, based on the weight of magnesium diboride.

20. The method of claim 18 wherein the weight of the dopant is based on the weight of boron and magnesium charged into the tube.
